(19) United States
(12) Patent Application Publication
(10) Pub. No.: US 2014/0165413 A1
(43) Pub. Date: Jun. 19, 2014

(54) CURVED SURFACE POWER PLANE

(71) Applicant: Paul Goodridge, South Australia (AU)

(72) Inventor: Paul Goodridge, South Australia (AU)

(21) Appl. No.: 14/234,744

(22) PCT Filed: Jul. 30, 2012
(86) PCT No.: PCT/AU2012/000892

§ 371 Date: Jan. 25, 2014

(30) Foreign Application Priority Data
Jul. 29, 2011 (AU) 2011903022

(51) Int. Cl. B27C 1/10; B27C 1/14

(52) U.S. Cl. CPC B27C 1/10; B27C 1/14
USPC 30/475; 30/481

(57) ABSTRACT

An electric plane with no or minimal sole plate. In a first embodiment the motor and drum are mounted in parallel in a housing with a guard that moves up and down to reveal varying amounts of cutting drum. In a second embodiment a cutting drum is mounted coaxially with a motor. The drum is mounted in a housing that rotates to reveal varying amounts of the drum and thus set the cutting depth

### FIELD OF THE INVENTION

This invention relates to a power plane for planning material surfaces, in particular a power plane suitable for use on curved surfaces.

### BACKGROUND TO THE INVENTION

Planes have long been used for smoothing surfaces, particularly wood, with power planes being a relatively modern variation providing for very fast removal of material from a surface. Power planes have evolved from hand planes and have a similar layout in having a long sole plate with a blade positioned approximately midway along the sole plate. For power planes the sole plate is split into two sections, fore and aft of the blade, with the aft section level with the extremities of the cutting blades and the fore section raised by the cut depth above the extremities of the blades. Whilst the long sole plate aids work on a flat surface it becomes a hindrance on curved surfaces.

On a concave surface a power plane will engage the surface being worked on the front and rear edges of the sole plate and consequently elevate the cutting blades away from the surface, possibly clear from the surface. This situation will make smoothing a concave surface difficult if not impossible.

On a convex surface a power plane will engage the surface being worked on the front edge of the rear sole plate and at some point along the front sole plate dependent on the curvature of the surface and the cutting depth. This situation will make working on a convex surface difficult as the depth of cut would vary with the curvature of the surface.

The above problems are further exacerbated on surfaces with a varying curve radius as the depth of cut will vary with the curve radius.

Some power planes have been developed with curved sole plates, both fixed and adjustable. Whilst going some way towards solving the problem, they are only suited for a particular surface curvature or require frequent adjustment.

The object of this invention is to provide a power plane that alleviates the above problems, or at least provides the public with a useful alternative.

### SUMMARY OF THE INVENTION

Therefore in one form of the invention there is proposed a power plane comprising a first housing; an electric motor within said housing drivingly coupled to and located in parallel with a drum with embedded cutting blades; and a second housing telescopically engaged with the first housing, wherein said second housing is moveable from a first position in which no cutting blade protrudes from said second housing to a second position in which said cutting blade protrudes from said second housing.

It should be noted that any one of the aspects mentioned above may include any of the features of any of the other aspects mentioned above and may include any of the features of any of the embodiments described below as appropriate.

### BRIEF DESCRIPTION OF THE DRAWINGS

The accompanying drawings, which are incorporated in and constitute a part of this specification, illustrate various implementations of the invention and, together with the description, serve to explain the advantages and principles of the invention.

FIG. 1 is a top perspective view of a plane of a first embodiment of the invention.

FIG. 2 is a bottom perspective view of the plane of FIG. 1 with the outer housing set for a first cut depth.

FIG. 3 shows the plane of FIG. 2 with the outer housing removed to reveal the inner housing.

FIG. 4 shows the plane of FIG. 2 with the outer housing set for a second cut depth.

FIG. 5 is a side cross sectional view of the plane of FIG. 2 cutting a piece of wood to a first depth.

FIG. 6 is a side cross sectional view of the plane of FIG. 4 cutting a piece of wood to a second depth.

FIG. 7 shows the plane of FIG. 1 with all housings removed.

FIG. 8 is a bottom perspective view of a plane according to a second embodiment of the invention.

FIG. 9 shows a blade drum of the invention.

FIG. 10 shows a plane of a third embodiment of the invention with guard extended.

FIG. 11 shows the plane of FIG. 10 with guard retracted.

FIG. 12 shows a rear sole plate assembly of the third embodiment.

FIGS. 13A and 13B shows a front sole plate assembly of the third embodiment.

FIG. 14 shows a plane with the sole plate assemblies of FIGS. 12 and 13A fitted

FIG. 15 shows the plane of FIG. 14 with rear sole plate locked and front sole plate retracted.

FIG. 16 shows the plane of FIG. 14 with front and rear sole plates locked together and retracted.

### LIST OF COMPONENTS

20 plane (first embodiment)

22 inner components

24 electric motor

25 motor axle

26 axle coupling

30 blade drum

32 drum axle

34, 35 blades

36 tapped holes

40 body

41 depth scale

42 depth marker

45 inner housing

46 inner front edge

47 inner rear edge

54 end cover

55 outer housing

56 outer front edge

57 outer rear edge

60, 61 wood block

62, 63 cutting arc

64, 65 cutting depth

66, 67 uncut surface

68, 69 cut surface

80 plane (second embodiment)

81 blade drum

82 main housing

83 outer housing

84 blade

85 (housing) front edge

86 (housing) rear edge

87 adjustable stop

90 blade drum

91 double sided blade

92, 93 half cylinders

94 holes

95 end pieces

100 plane (third embodiment)

102 housing body

104 left end

105 right end

106 handles

110 depth gauge

111 gauge gradations

112 gauge holder

114 gauge lock

116 gauge marker

118 gauge end

120 blade guard

122 guard stop

124 spring guides

130 guard springs

140 blade drum

142 drum ends

150 rear sole plate assembly

152 rear sole plate

154 sole shafts

156 shaft locks

160 front sole plate assembly

162 front sole plate

164 shaft guides

166 shaft holes

168 spring ledges

169 sole locks

170 sole plate springs

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

The invention is essence an electric plane with no or minimal sole plate. In a first embodiment a cutting drum is mounted coaxially with a motor. The drum is mounted in a housing that rotates to reveal varying amounts of the drum and thus set the cutting depth. In a second embodiment the motor and drum are mounted in parallel in a housing with a guard that moves up and down to reveal varying amounts of cutting drum.

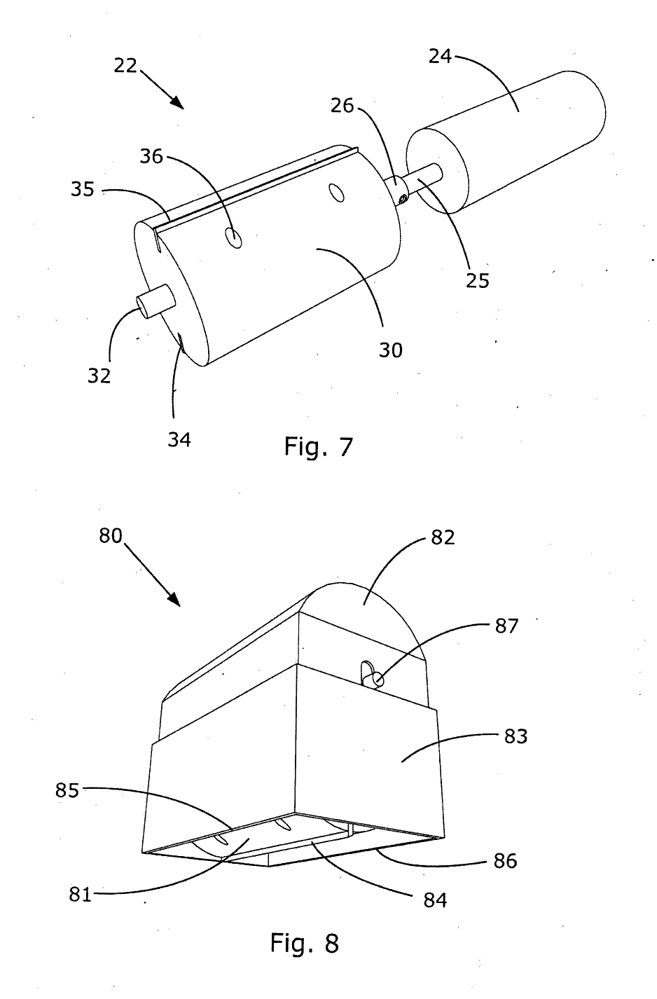

A first embodiment of the invention is the plane 20. It is best described starting with its main internal components 22 as shown in FIG. 7; comprising an electric motor 24 coaxially coupled to a drum 30 with embedded cutting blades 34 and 35. The motor 24 and drum 30 are coupled via their respective axles 25 and 32 and an axle coupling 26. The blades 34 and 35 are held in slots in the drum 30 by means of grub screws (not shown) in tapped holes 36.

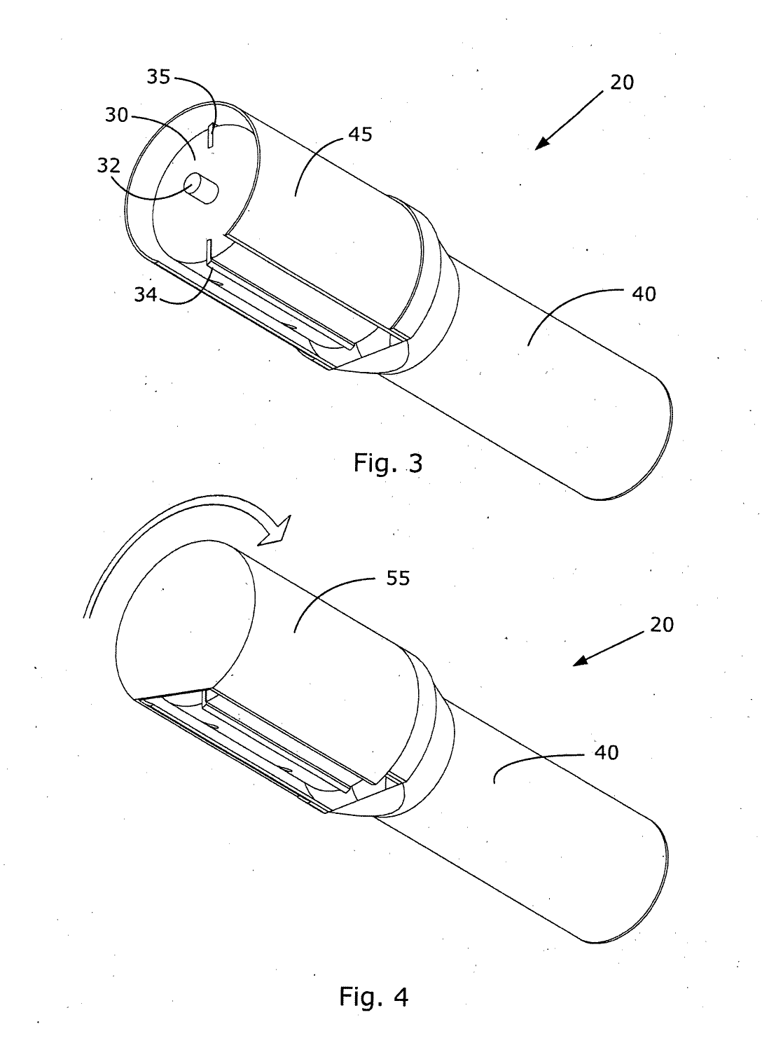

As shown in FIG. 3 the plane 20 includes a body 40 for covering and supporting the motor 24 to which is fixedly attached an inner housing 45 that covers the drum 30 with suitable clearance of the blades 34 and 35. The inner housing 45 is in the form of a hollow cylinder with a segment removed to provide exposure to the blades 34 and 35. As shown in FIG. 4, an outer housing 55 is fitted over the inner housing 45. The Outer housing 55 is also in the form of a hollow cylinder with a segment removed and has an inner diameter slightly larger than the outer diameter of the inner housing, thus allowing the outer housing to rotate about a common axis with respect to the inner housing. As the outer housing 55 rotates with respect to the inner housing 45 the blades 34 and 35 are exposed to varying degrees, thus allowing the plane 20 to cut to varying depths. FIG. 4 shows the outer housing 55 positioned for a shallow cut; in contrast FIG. 2 shows the outer housing set for maximum cutting depth.

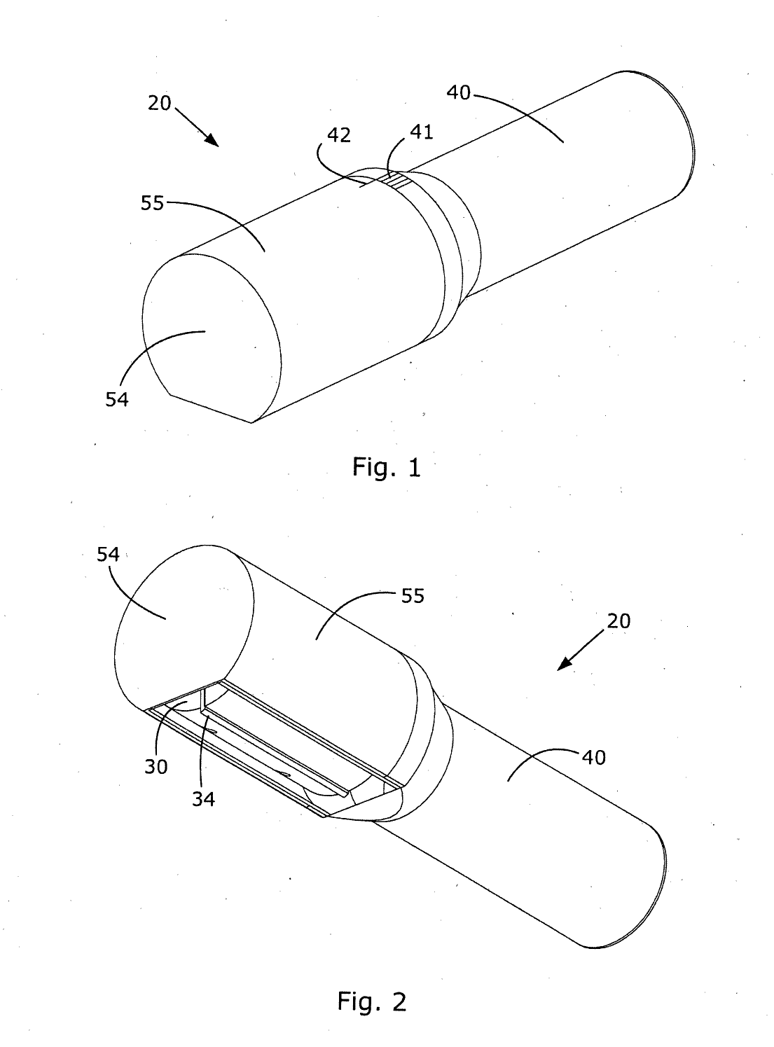

FIG. 1 shows the plane 20 from above such that only the housing 40 and outer covering 55 are visible. The housing 40 incorporates a depth scale 41 which together with a depth marker 42 on the outer housing 45 indicates the depth of cut that will be produced by the plane.

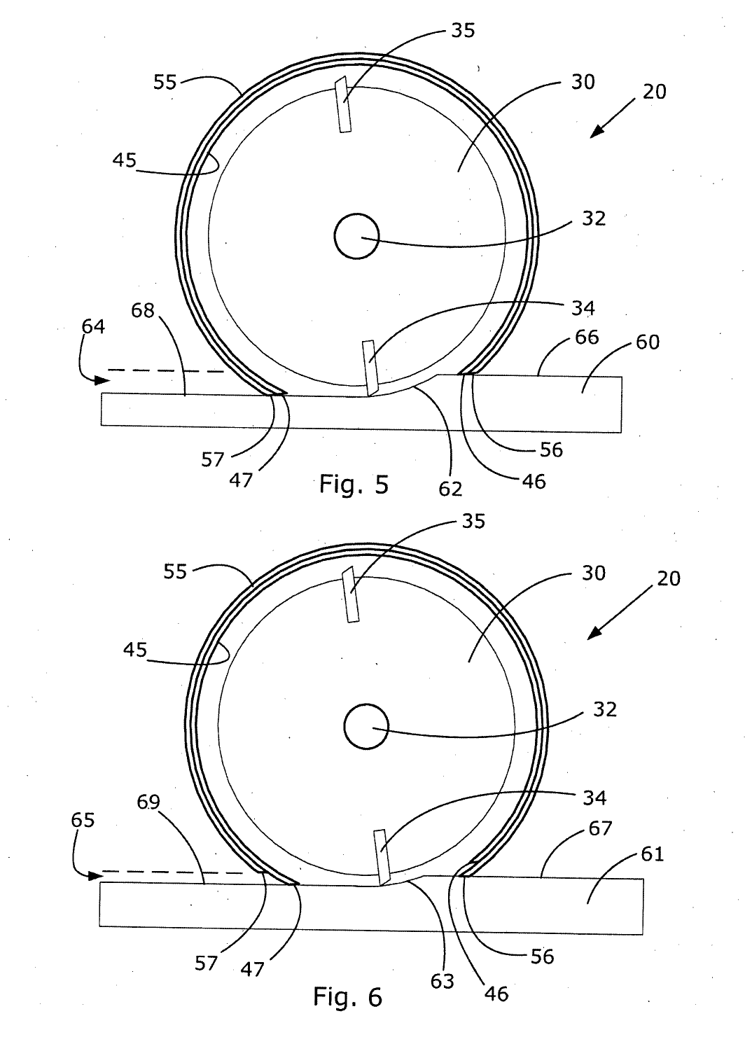

The interaction of the inner 45 and outer 55 housings to set the cutting depth is shown in FIGS. 5 and 6 which show the plane 20 from the side with the end cover 54 removed.

In FIG. 5 the plane 20 is shown cutting into a piece of wood 60 to the maximum depth 64. For a maximum depth cut the inner housing 45 and outer 55 housings are aligned such that the inner front edge 46 is adjacent to the outer front edge 56 and the inner rear edge 47 is adjacent to the outer rear edge 57. As the plane 20 is moved from left to right in FIG. 5 the front edges 46 and 56 ride along the uncut surface 66 and the rear edges 47 and 57 ride along the cut surface whilst the rotating blades 34 and 35 cut into the wood 60 with a cutting arc 62.

In contrast to the maximum depth cut 64 demonstrated in FIG. 5, FIG. 6 shows the plane 20 cutting to a lesser cutting depth 65. The inner housing 45 and outer housing 55 are offset from each other such that aperture through which the blades 34 and 35 protrude is reduced in size resulting in the lesser cut depth 65. As the plane 20 is moved from left to right in FIG. 6 the front edge 56 of the outer housing 55 and rides along the uncut surface 67 and the rear edge 47 of the inner housing ride along the cut surface whilst the rotating blades 34 and 35 cut into the wood 61 with a cutting arc 63. The front edge 46 of the inner housing 45 and the rear edge 57 of the outer housing 55 remain clear of the wood 61 being cut.

In use a user would hold the body 40 in a first hand and the outer housing 55 in a second hand. Optionally a handle (not shown) may be attached to the end cover 54. The end cover 54 further includes a retractable shutter (not shown) that emerges beyond the depth of the blades to allow the plane to be rested on a surface without the blades coming in contact with the surface A guide may also be fitted to the end cover to facilitate running the plane along an edge.

In a second embodiment of the invention there is a plane 80 shown viewed from below in FIG. 8 in which the motor is positioned in parallel above the blade drum 81 in a main housing 82 with the motor and drum being joined together by a by a belt drive mechanism. An adjustable outer housing 83 moves up and down with respect to the main housing 82 to reveal a varying amount of the blades 84 and thus providing for a variable depth cut. Similarly to the first embodiment, the front edge 85 of the outer housing 83 will ride on the uncut surface whilst the rear edge 86 rides on the cut surface with the blades 84 cutting in between. An adjustable stop 87 is fitted to limit the movement of the outer housing 83 and subsequent depth of the cut. The outer housing 83 is spring biased to a maximum extension to ensure that the blades are protected when not cutting.

In use, a plane of the second embodiment would be grasped at both, sides between a thumb and fingers and pushed down against a surface to move back the outer housing 83 against its spring bias and expose the cutting blades 84.

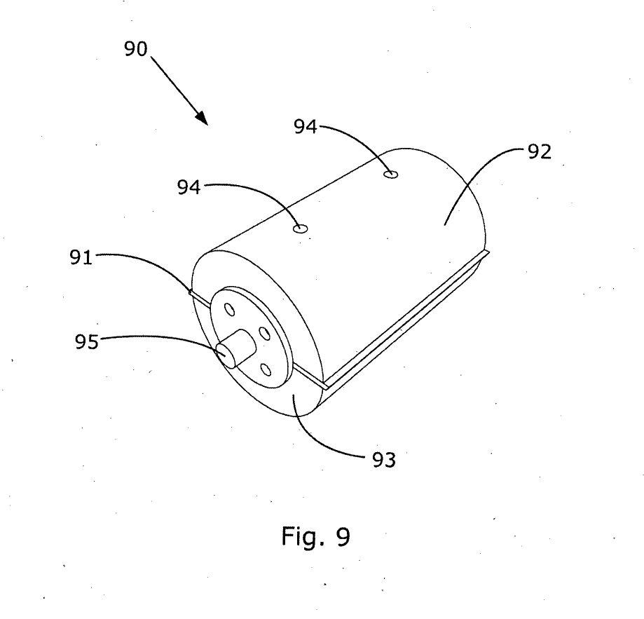

Details of an embodiment of a blade drum 90 is shown in FIG. 9 in which a double sided blade 91 is held between two half cylinders 92 and 93 of the drum such that it presents a cutting edge on either side of the drum. The half cylinders and blade are secured by screws fitted through holes 94 in the half cylinders. The axle for the drum is provided by end pieces 95 and 96 affixed to either end of the drum. This arrangement provides for less parts and easier depth alignment of the two cutting edges compared with conventional arrangements using two separate blades.

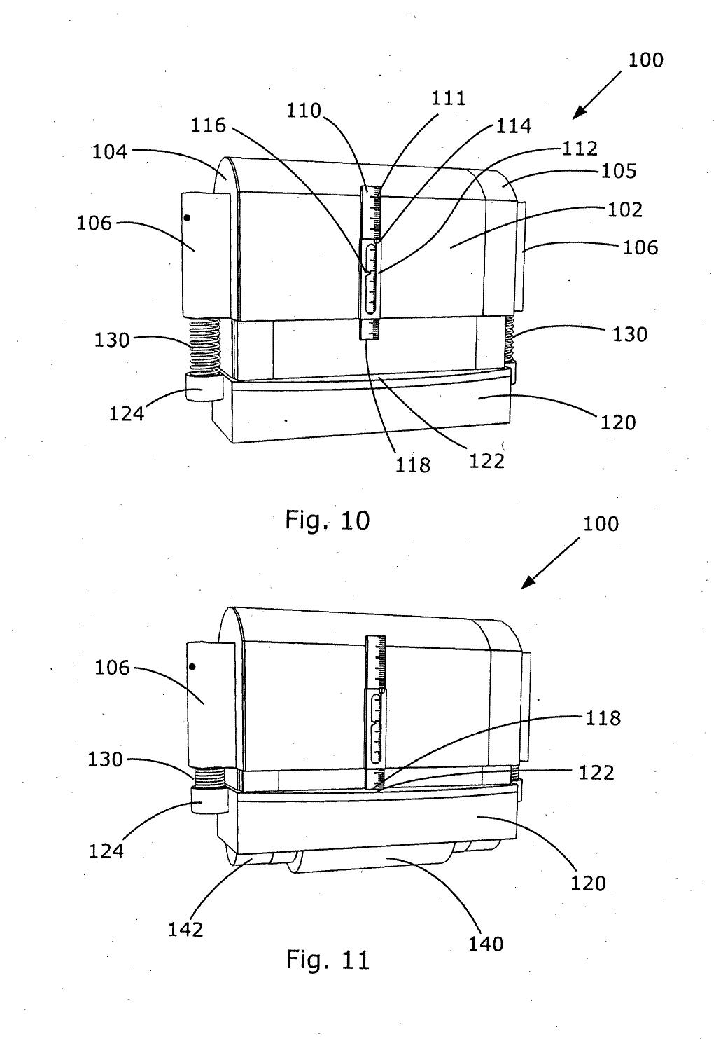

A plane 100 of a third embodiment of the invention is shown in FIGS. 10 to 16. This embodiment is similar to the plane 80 of the second embodiment in that the motor and cutting drum are mounted in parallel in a housing with a guard that moves up and down to set the cutting depth.

As shown in FIGS. 10 and 11 the plane 100 comprises housing body 102 with left end 104 and right end 105. Both ends have an attached handle 106 for manipulating the plane. The body 102 encloses a motor (not shown) driving a blade drum 140 mounted below and in parallel with the motor. The blade drum is driven by a toothed belt, but may also be driven by other means such as a chain, gears or a flat belt. The plane includes a blade guard 120 which telescopically engages the housing body. When fully extended the blade guard completely envelopes the blade drum 140 thus preventing the blade drum coming in contact with a surface on which the plane may be placed. When the blade guard 120 is retracted the blade drum 140 is exposed and able to cut. By varying the extension of the guard 120 the depth of cut achieved by the plane is controlled. A spring 130 attached to the handle 106 and spring guide 124 (which in turn is attached to the guard 120) will act to extend the guard 120 and thus protect the blade drum from accidental contact.

The plane 100 includes depth gauge 110 which may move vertically in gauge holder 112. The position of the gauge 110 is set with aid of gradations 111 on the gauge and a marker 116 attached to the holder 112. The gauge 110 is held firmly in place by gauge lock 114 which is a grub screw or the like. The gauge end 118 serves to limit the travel of the blade guard 120 when it comes in contact with guard stop 122. The gradations 111 are marked to reflect the resulting depth of cut achieved. A cut of up to 22 mm may be achieved in practice. Such a deep cut is limited to material narrower than the blade drum 140, which is typically 82 mm. On wider material the depth of cut is limited by the presence of the drum ends 142 which house supports, bearings and drive mechanisms for the drum 140. Wide cuts are limited in depth to the difference in radius of the blade drum 140 and drum ends 142 which is typically 5 mm.

In use the desired depth of cut would be set first with the depth gauge 110. The plane 100 would then be grasped by both handles 106 and pushed down onto the workpiece to retract the blade guard 120 and reveal the blade drum 140 to cut into the workpiece. As with the above described embodiments, the plane 100 can readily operate on both concave and convex work surfaces.

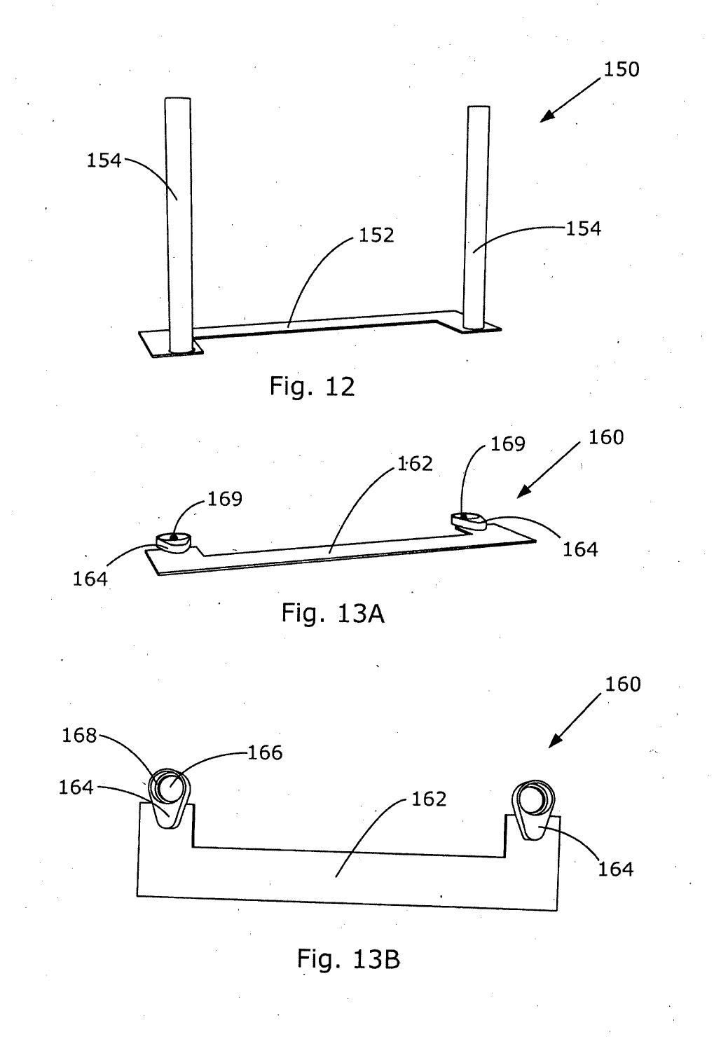

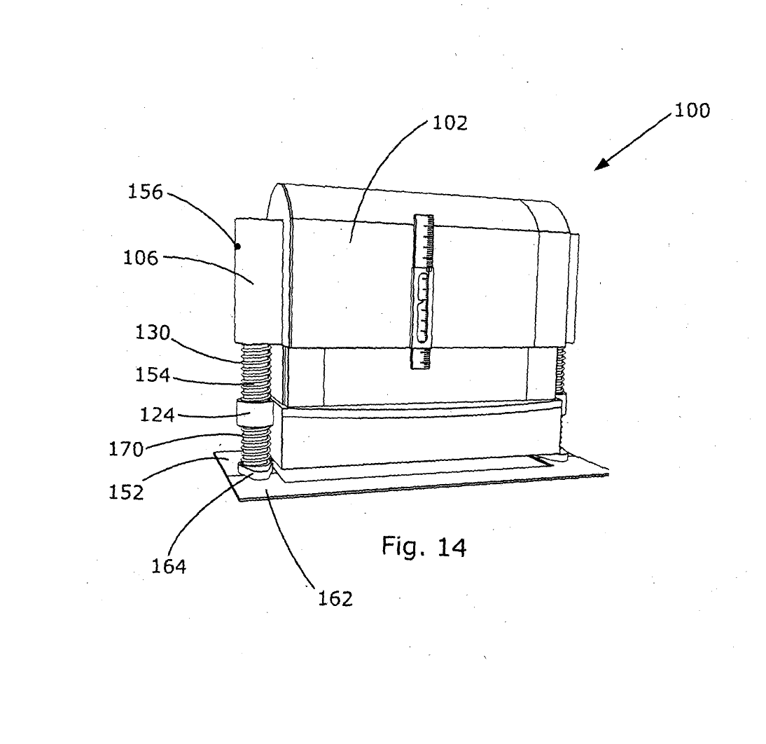

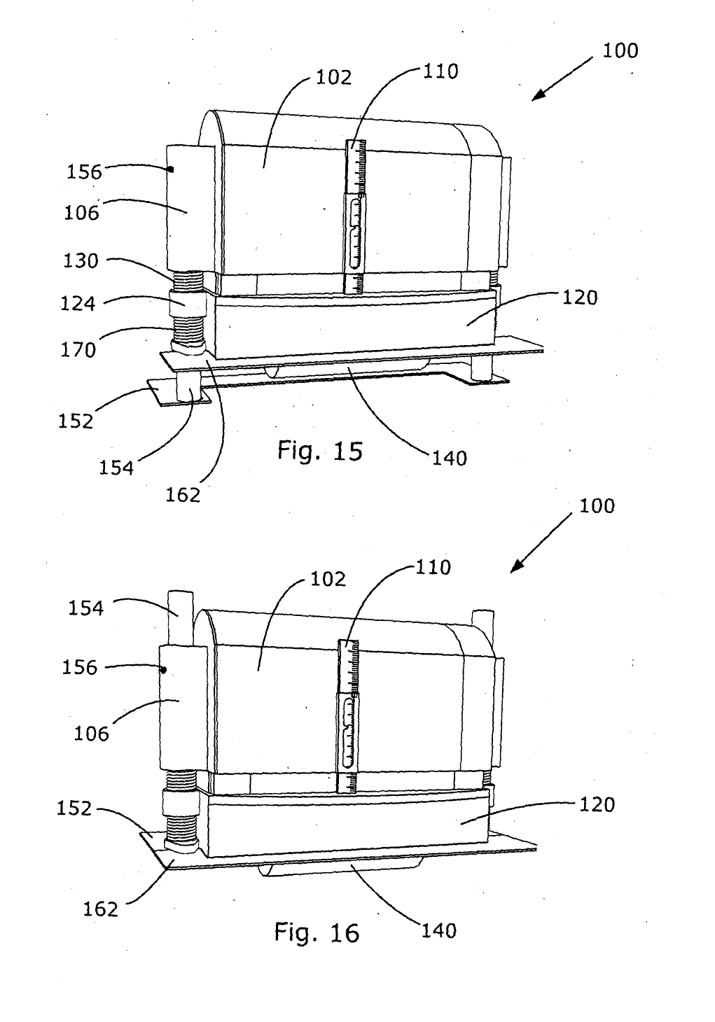

Whilst having no sole plates attached to the plane maximizes cutting ability on curved surfaces, having the ability to fit a sole plate can be advantageous in some scenarios. Sole plates for instance can include grooves to enable accurate cutting of bevels or outriggers to help position the plane. The present plane 100 may be fitted with sole plate assemblies as shown in FIGS. 12 and 13A and 13B. A plane with sole plates fitted is shown in FIG. 14 with the blade guard 120 extended and in two different scenarios with the blade guard retracted in FIGS. 14 and 15. The sole plates are narrow so they have minimal impact on the ability of the plane to operate on curved surfaces.

FIG. 12 shows a rear sole plate assembly 150 comprising rear sole plate 152 and sole shafts 154. The sole shafts 154 fit within matching holes in the handles 106, providing guides for the vertical movement of the plane 100 with respect to the rear sole plate 152. The shafts 154 may be fixed in place by aid of shaft locks 156 which are grub screws or the like within the handles 106.

FIGS. 13A and 13B show a front sole plate assembly 160 comprising front sole plate 162 and shaft guides 164. The shaft guides 164 include shaft holes 166 through which the sole shafts 154 of the rear sole plate assembly 150 pass thus movingly attaching the front and rear sole plate assemblies together. The front assembly 160 may move up and down the shafts 154 of the rear assembly 160 or the two assemblies may be fixed together with aid of sole locks 169 which are grub screws or the like. As the rear section of the shaft guides 164 sits upon the rear sole plate 152, movement of the two sole plates is interconnected. The front sole plate 152 may sit level with or above the rear sole plate 162, but never beneath it. The shaft guides 164 further include spring ledges 168 for holding springs 170.

A plane 100 with front and rear sole plate assemblies fitted is shown in FIG. 14. The sole shafts 154 pass through shaft guides 164, spring guides 124 and handles 106 to hold the various elements together and ensure that they can only move vertically in relation to each other. The sole shafts 154 also sit within springs 130 and 170 which are free to move in relation to each other. Sole locks 169 (visible in FIG. 13B) may be used to ensure that the front 162 and rear 152 sole plates move in unison if desired and shaft locks 156 may be used to ensure that the rear sole plate does not move with respect to the housing body 102. The blade guard 120 is free to move vertically up and down the sole shafts 154. The inside aperture of the combined sole, plates is smaller than the outer edge of the blade guard 120 so that the blade guard will move up in unison with the sole plates. Sole plate springs 170 act to push the front sole plate 162 down.

In a further embodiment of the invention (not shown) there is a plane similar in arrangement to the plane 20 shown in FIGS. 1-5. In contrast the inner shell 45 is absent and the outer shell fitted in an eccentric manner with respect to the drum axle 32 such that rotation of the outer shell reveals a varying amount of the drum and blades thus controlling the cutting depth.

FIGS. 15 and 16 demonstrate two different ways to use the plane 100 dependent on how the various components are locked together.

In FIG. 15 shaft locks 156 are secured to prevent vertical movement of the rear sole plate 152 and sole locks 169 are unsecured to allow the front sole plate 162 to move in relation to the rear sole plate. The front sole plate 162 and the blade guard 120 are free to move up thus reveal blade drum 140 to cut, with the cut depth being set by gauge 110. Rear sole plate 152 will ride along the cut surface of the work piece. When the plane 100 is removed from the work piece springs 130 and 170 will push the guard 120 and front sole plate 162 away from the plane body 102 thus covering blade drum 140 to prevent accidental contact.

In FIG. 16 shaft locks 156 are unsecured to allow vertical movement of the rear sole plate 152 and sole locks 169 are secured to ensure that the front sole plate 162 and rear sole plate 152 move in unison. The attached sole plates 152 and 162 and the blade guard 1.20 are free to move up thus reveal blade drum 140 to cut, with the cut depth being set by gauge 110. When the plane 100 is removed from the work piece springs 130 and 170 will push the guard 120 and both sole plates 152 and 162 away from the plane body 102 thus covering blade drum 140 to prevent accidental contact.

Whilst the operation of the plane has been shown on a flat surface in the figures, it will work equally as well all convex surfaces and on concave surfaces with a radius of curvature greater than that of the outer housing (approximately 30 mm).

The various embodiments of the plane offer a further advantage over conventional planes in that they are able to cut whilst moving in either direction over a work piece.

The reader will now appreciate the operation and advantages of the present invention in providing a plane simple in construction but more versatile than its conventional predecessors allowing curves to be readily cut on both concave and convex surfaces.

Further advantages and improvements may very well be made to the present invention without deviating from its scope. Although the invention has been shown and described in what is conceived to be the most practical and preferred embodiment, it is recognized that departures may be made therefrom within the scope and spirit of the invention, which is not to be limited to the details disclosed herein but is to be accorded the full scope of the claims so as to embrace any and all equivalent devices and apparatus. Any discussion of the prior art throughout the specification should in no way be considered as an admission that such prior art is widely known or forms part of the common general knowledge in this field.

In the summary of the invention, except where the context requires otherwise due to express language or necessary implication, the word “comprising” is used in the sense of “including”, i.e. the features specified may be associated with further features in various embodiments of the invention.

1. A power plane comprising a first housing; an electric motor within said housing drivingly coupled to and located in parallel with a drum with embedded cutting blades; and a second housing telescopically engaged with the first housing, wherein said second housing is moveable from a first position in which no cutting blade protrudes from said second housing to a second position in which said cutting blade protrudes from said second housing.

2. A power plane as in claim 1 further including a fixedly moveable gauge, wherein the position of the gauge sets the second position of said housing.

3. A power plane as in claim 1 further comprising first springs to bias said second housing to said first position.

4. A power plane as in claim 3 wherein:
said first housing further comprises handles at a first and second end;
said second housing further comprises lugs at a first and second end; and
said first springs are located between said handles and said lugs.

5. A power plane as in claim 4 further comprising a detachable sole plate; said sole plate comprising a planar member with an aperture through which the cutting blades may protrude and shafts perpendicular to said planar member; wherein said first sole plate is moveably attached to said plane by means of said shafts passing through axially aligned bores in said first housing handles and said second housing lugs.

6. A power plane as in claim 5 wherein:
said planar member comprises a front section and a rear section;
said rear section is fixedly attached to said shafts; and
said front section is moveably attached to said shafts.

7. A power plane as in claim 6 wherein said front section is moveably attached to said shafts by means of an integral attachment member including an aperture through which said shafts pass.
